(19) United States
(12) Patent Application Publication
(10) Pub. No.: US 2026/0115796 A1
(43) Pub. Date: Apr. 30, 2026

(54) DEVICE FOR REDUCING PREPARATION DEFECTS OF THREE-DIMENSIONAL PRINTING TECHNOLOGY BY FOLLOWING MICRO-ROLLING

(71) Applicant: Wenzhou University, Wenzhou (CN)

(72) Inventors: Tiehui Fang, Wenzhou (CN); Pengpeng Xia, Wenzhou (CN); Jiaxian Jin, Wenzhou (CN); Yanfei Geng, Wenzhou (CN); Xizhang Chen, Wenzhou (CN); Wei Xue, Wenzhou (CN); Zheyu Yuan, Wenzhou (CN); Le Qiu, Wenzhou (CN); Jiale Chen, Wenzhou (CN)

(21) Appl. No.: 19/373,269

(22) Filed: Oct. 29, 2025

(30) Foreign Application Priority Data
Oct. 31, 2024 (CN) 202411546941.5

(51) Int. Cl. B22F 10/50; B33Y 40/00

(52) U.S. Cl. CPC B22F 10/50; B33Y 40/00

(57) ABSTRACT

A device for reducing preparation defects of three-dimensional (3D) printing technology by following micro-rolling includes a laser. The laser is connected to an electric telescopic rod through a fastener, a pressing tool is arranged at a right side position of an end of the electric telescopic rod, and a main roller is arranged at the pressing tool; and a liquid pipe bracket is arranged at a left side position of an end of the electric telescopic rod, a cooling liquid pipe distributed obliquely is arranged at the liquid pipe bracket, a liquid outlet of the cooling liquid pipe is located behind the main roller, and a pipe joint of the cooling liquid pipe is connected to an external freezing liquid pipe. According to the present disclosure, the microstructure of a deposited layer can be refined, surface defects can be reduced, and the forming quality and performance can be improved.

### CROSS-REFERENCE TO RELATED APPLICATION

This application claims priority of Chinese Patent Application No. 202411546941.5, filed on Oct. 31, 2024, the entire contents of which are incorporated herein by reference.

### TECHNICAL FIELD

The present disclosure relates to the technical field of three-dimensional (3D) printing, and in particular to a device for reducing preparation defects of 3D printing technology by following micro-rolling.

### BACKGROUND

Laser energy directed deposition, also known as laser 3D printing technology, melts and solidifies metal powder through a laser beam and accumulates it layer by layer, and ultimately prepares 3D components. In this process, the energy of the laser beam is accurately controlled and oriented to achieve precise manufacturing, and it has a wide range of applications in aerospace, medical and health, national defense and military fields, etc. But at the same time, when preparing high-performance materials, a large number of voids, cracks and columnar crystal coarsening will be produced in the laser 3D printing process, which ultimately reduces the performance of the materials. In view of the defects of laser cladding preparation, various scholars have studied various methods and functions of auxiliary laser cladding preparation, including ultrasonic vibration-assisted laser cladding to reduce the generation of pores, steady-state magnetic field-assisted laser cladding to suppress the generation of cracks, and liquid nitrogen cooling to reduce the microstructure size. The existing auxiliary laser cladding technology has a single effect on reducing the defects of laser cladding preparation, and cannot solve the problems of pores, cracks, and coarse grains at the same time. Based on this, the present disclosure provides a device for reducing preparation defects of 3D printing technology by following micro-rolling.

### SUMMARY

An objective of the present disclosure is to provide a device for reducing preparation defects of 3D printing technology by following micro-rolling to solve the above-mentioned problems.

To solve the above technical problems, the present disclosure adopts the following technical solutions.

The present disclosure provides a device for reducing preparation defects of 3D printing technology by following micro-rolling, including a laser. The laser is connected to an electric telescopic rod through a fastener, a pressing tool is arranged at a right side position of an end of the electric telescopic rod through an obliquely arranged connecting frame, and a main roller is arranged at the pressing tool; and a liquid pipe bracket is arranged at a left side position of an end of the electric telescopic rod through a bracket, a cooling liquid pipe distributed obliquely is arranged at the liquid pipe bracket, a liquid outlet of the cooling liquid pipe is located behind the main roller, and a pipe joint of the cooling liquid pipe is connected to an external freezing liquid pipe.

Further, the pressing tool has a U-shaped structure, and the main roller is rotatably arranged at an opening of the U-shaped structure of the pressing tool by a stud bolt.

Further, an auxiliary wheel I and an auxiliary wheel II are symmetrically arranged below the U-shaped structure of the pressing tool.

Further, the auxiliary wheel I and an auxiliary wheel II are arranged at a bottom of the pressing tool by a captive screw I and a captive screw II.

Further, the pressing tool is fixed to the connecting frame by a pressing tool screw spike and a pressing tool nut matched therewith, and a gasket is arranged between the pressing tool and the connecting frame.

Further, a projection of the main roller is tangent to a spot diameter of the laser.

Further, the fastener and the bracket are connected to the electric telescopic rod by connecting bolts.

Further, the bracket and the liquid pipe bracket are connected together by a liquid nitrogen screw.

Further, a liquid pipe nut I and a liquid pipe nut II symmetrically distributed on two sides of the liquid pipe bracket are arranged at the cooling liquid pipe.

Compared with the related art, the present disclosure has the following advantages.

According to the present disclosure, in a molten state of a deposited layer, micro-rolling and cooling are performed at the same time, which is not aimed at a single defect, but can reduce all defects, on the one hand, the generation of voids and thermal stress of the deposited layer can be reduced, columnar crystals can be refined and deformation or cracking of the deposited layer can be prevented; and on the other hand, the shrinkage of the material is reduced, the roller applies micro-rolling force in the cooling process, and a smoother and tighter surface effect can be obtained, which can further reduce the occurrence of surface defects and reduce the surface roughness of the deposited layer. In summary, the device for reducing preparation defects of 3D printing technology by following micro-rolling of the present disclosure can refine the microstructure of the deposited layer, reduce the surface defects, and improve forming quality and performance.

### BRIEF DESCRIPTION OF THE DRAWINGS

The present disclosure will be further described below with reference to the description of the drawings.

FIG. 1 is a front view of a device for reducing preparation defects of 3D printing technology by following micro-rolling according to the present disclosure;

FIG. 2 is a mounting structural diagram of a pressing tool;

FIG. 3 is a mounting structural diagram of a cooling liquid pipe;

FIG. 4 is an explosive schematic structural diagram of the pressing tool;

FIG. 5 is an explosive diagram of the cooling liquid pipe;

FIG. 6 is a mounting structural diagram of an electric telescopic rod; and

FIG. 7 is a structural diagram showing that a projection of a main roller is tangent to a spot diameter.

Reference numerals and denotations thereof: 1—electric telescopic rod; 2—fastener; 3—connecting frame; 4—pressing tool; 5—main roller; 6—auxiliary wheel I; 7—auxiliary wheel II; 8—cooling liquid pipe; 9—bracket; 10—liquid pipe bracket; 11—laser; 12—pressing tool screw spike; 13—gasket; 14—pressing tool nut; 15—stud bolt; 16—pipe joint; 17—liquid pipe nut I; 18—liquid pipe nut II; 19—liquid nitrogen screw; 20—captive screw I; 21—captive screw II; 22—substrate; and 23—connecting bolt.

### DETAILED DESCRIPTION

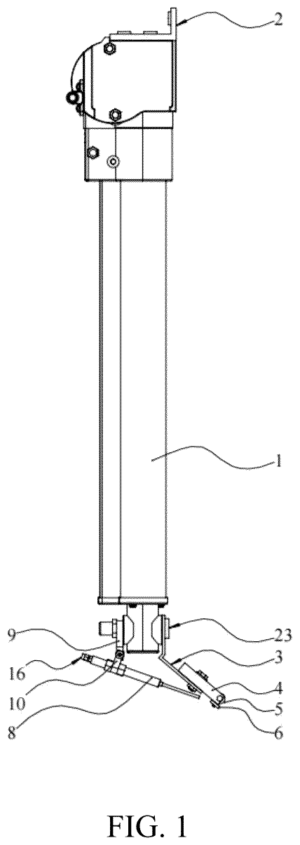

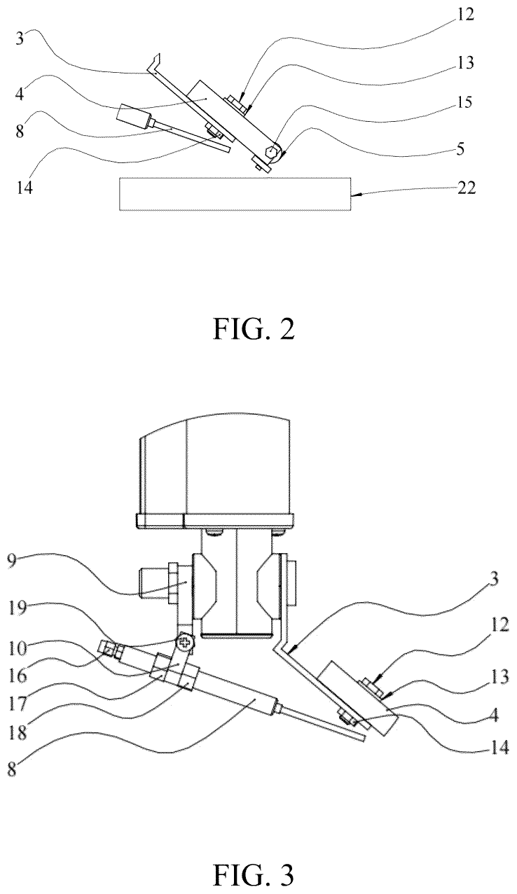

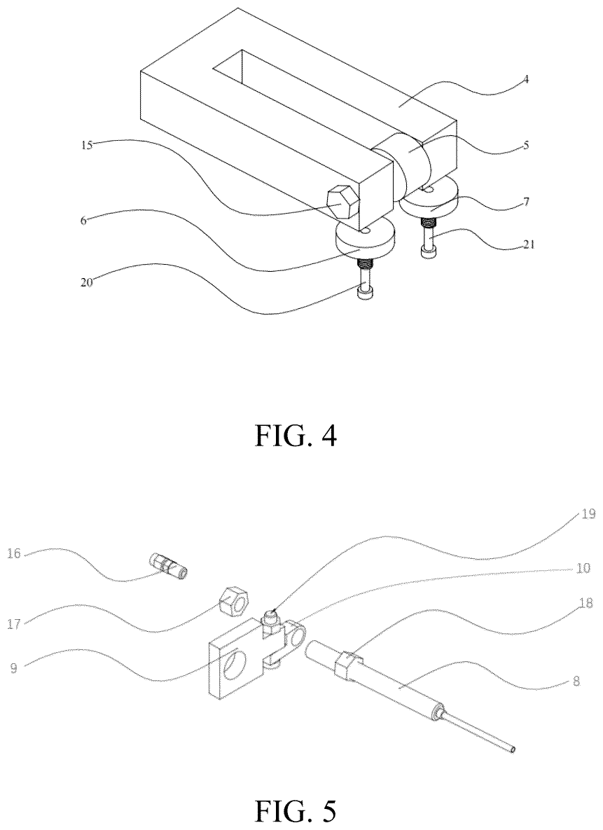

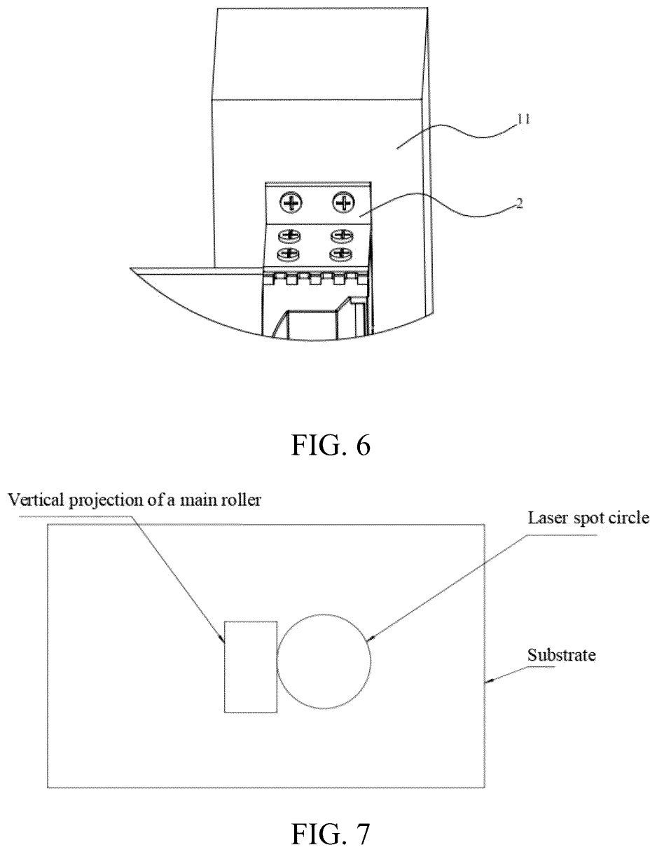

As shown in FIGS. 1-7, a device for reducing preparation defects of 3D printing technology by following micro-rolling includes a laser 11, and the laser 11 is connected to an electric telescopic rod 1 through a fastener 2. In this example, the electric telescopic rod is purchased from a Lida push rod manufacturing factory, and the rod includes a silent pure copper motor with a stroke of 10 mm to 1500 mm, the push rod can be controlled by a remote controller and can be stopped at any time. A pressing tool 4 is mounted on a right side position of an end of the electric telescopic rod 1 through an obliquely mounted connecting frame 3, and a main roller 5 is mounted on the pressing tool 4. A distance between the main roller 5 and a substrate 22 can be adjusted through a forming thickness of a deposited layer. In this example, the electric telescopic rod 1 adjusts the distance between a surface of the main roller 5 and the substrate 22 to be 3 mm-4 mm to ensure that the deposited layer is in a molten state during micro-rolling.

The pressing tool 4 has a U-shaped structure, and the main roller 5 is rotatably mounted at an opening of the U-shaped structure of the pressing tool 4 by a stud bolt 15. An auxiliary wheel I 6 and an auxiliary wheel II 7 are symmetrically mounted below the U-shaped structure of the pressing tool 4. The auxiliary wheel I 6 and the auxiliary wheel II 7 can micro-roll two side surfaces of the deposited layer, on the one hand, the side surfaces can be smoother, and on the other hand, a molten pool can be prevented from overflowing to two sides due to a pressure of the main roller 5, thereby affecting the compactness of the deposited layer. The auxiliary wheel I 6 and the auxiliary wheel II 7 are mounted on a bottom of the pressing tool 4 by a captive screw I 20 and a captive screw II 21.

The pressing tool 4 is fixed to the connecting frame 3 by a pressing tool screw spike 12 and a pressing tool nut 14 matched therewith, and a gasket 13 is mounted between the pressing tool 4 and the connecting frame 3. Specifically, a mounting position of the pressing tool 4 on the connecting frame 3 is adjusted by the pressing tool nut 14, ensuring that a projection of the main roller 5 is tangent to a spot diameter of the laser 11.

A liquid pipe bracket 10 is mounted at a left side position of an end of the electric telescopic rod 1 through a bracket 9, a cooling liquid pipe 8 distributed obliquely is mounted on the liquid pipe bracket 10, a liquid outlet of the cooling liquid pipe 8 is located behind the main roller 5, and a pipe joint 16 of the cooling liquid pipe 8 is connected to an external freezing liquid pipe. A liquid pipe nut I 17 and a liquid pipe nut II 18 symmetrically distributed on two sides of the liquid pipe bracket 10 are mounted on the cooling liquid pipe 8. By adjusting mounting positions of the liquid pipe nut I 17 and the second liquid pipe nut II 18, a distance between the cooling liquid pipe 8 and the main roller 5 can be adjusted, and the cooling liquid pipe 8 follows the roller closely to cool the roller and indirectly cool the deposited layer at the same time.

Both the fastener 2 and the bracket 9 are connected to the electric telescopic rod 1 by connecting bolts 23.

The bracket 9 and the liquid pipe bracket 10 are connected together by a liquid nitrogen screw 19.

The use method of the present disclosure is as follows.

In step 1, the electric telescopic rod 1 adjusts a distance between a surface of the main roller 5 and the substrate 22 to be 3 mm-4 mm to ensure that the deposited layer is in a molten state during micro-rolling.

In step 2, the mounting position of the pressing tool 4 on the connecting frame 3 is adjusted by the pressing tool nut 14 until the projection of the main roller 5 is tangent to the spot diameter of the laser 11 (as shown in FIG. 7).

In step 3, the distance between the cooling liquid pipe 8 and the main roller 5 is adjusted by adjusting the liquid pipe nut I and the liquid pipe nut II, and the cooling liquid pipe 8 follows the roller closely to cool the roller and indirectly cool the deposited layer at the same time.

In step 4, appropriate process parameters including laser power, scanning speed, and spot diameter are selected for printing.

In step 5: when the deposited layers are in a molten state, the deposited layer is micro-rolled on three sides (i.e., an upper surface and two side surfaces of the deposited layer) by the main roller 5, auxiliary wheel I 6, and auxiliary wheel II 7, the appearance of pores can be reduced, the compactness of the material can be improved, at the same time, the growth direction of columnar crystals in each deposited layer can be changed in the process of micro-rolling, and the overall performance of the material can be improved.

The above-mentioned examples merely describe the preferred ways of the present disclosure and do not limit the scope of the present disclosure. Various modifications and improvements made to the technical solutions of the present disclosure by those skilled in the art without departing from the spirit of the present disclosure shall fall within the scope of protection determined by the claims of the present disclosure.

1. A device for reducing preparation defects of three-dimensional (3D) printing technology by following micro-rolling, comprising a laser (11), wherein the laser (11) is connected to an electric telescopic rod (1) through a fastener (2), a pressing tool (4) is arranged at a right side position of an end of the electric telescopic rod (1) through an obliquely arranged connecting frame (3), and a main roller (5) is arranged at the pressing tool (4); and a liquid pipe bracket (10) is arranged at a left side position of an end of the electric telescopic rod (1) through a bracket (9), a cooling liquid pipe (8) distributed obliquely is arranged at the liquid pipe bracket (10), a liquid outlet of the cooling liquid pipe (8) is located behind the main roller (5), and a pipe joint (16) of the cooling liquid pipe (8) is connected to an external freezing liquid pipe.

2. The device for reducing preparation defects of 3D printing technology by following micro-rolling according to claim 1, wherein the pressing tool (4) has a U-shaped structure, and the main roller (5) is rotatably arranged at an opening of the U-shaped structure of the pressing tool (4) by a stud bolt (15).

3. The device for reducing preparation defects of 3D printing technology by following micro-rolling according to claim 2, wherein an auxiliary wheel I (6) and an auxiliary wheel II (7) are symmetrically arranged below the U-shaped structure of the pressing tool (4).

4. The device for reducing preparation defects of 3D printing technology by following micro-rolling according to claim 3, wherein the auxiliary wheel I (6) and the auxiliary wheel II (7) are arranged at a bottom of the pressing tool (4) by a captive screw I (20) and a captive screw II (21).

5. The device for reducing preparation defects of 3D printing technology by following micro-rolling according to claim 1, wherein the pressing tool (4) is fixed to the connecting frame (3) by a pressing tool screw spike (12) and a pressing tool nut (14) matched therewith, and a gasket (13) is arranged between the pressing tool (4) and the connecting frame (3).

6. The device for reducing preparation defects of 3D printing technology by following micro-rolling according to claim 1, wherein a projection of the main roller (5) is tangent to a spot diameter of the laser (11).

7. The device for reducing preparation defects of 3D printing technology by following micro-rolling according to claim 1, wherein the fastener (2) and the bracket (9) are connected to the electric telescopic rod (1) by connecting bolts (23).

8. The device for reducing preparation defects of 3D printing technology by following micro-rolling according to claim 1, wherein the bracket (9) and the liquid pipe bracket (10) are connected together by a liquid nitrogen screw (19).

9. The device for reducing preparation defects of 3D printing technology by following micro-rolling according to claim 1, wherein a liquid pipe nut I (17) and a liquid pipe nut II (18) symmetrically distributed on two sides of the liquid pipe bracket (10) are arranged at the cooling liquid pipe (8).
